(19) United States
(12) Patent Application Publication
(10) Pub. No.: US 2009/0195667 A1
(43) Pub. Date: Aug. 6, 2009

(54) CAMERA SYSTEM WITH ISOLATOR AND SEAL FOR A WEAPON

(76) Inventor: Ronald Charles Schofield, JR., Saline, MI (US)

Correspondence Address: SCHOX PLC, 730 Florida Street #2, San Francisco, CA, 94110, US

(21) Appl. No.: 12/351,453

(22) Filed: Jan. 9, 2009

Related U.S. Application Data
(63) Continuation-in-part of application No. 12/110,167, filed on Apr. 25, 2008.
(60) Provisional application No. 60/914,540, filed on Apr. 27, 2007.

(51) Int. Cl. H04N 5/225; G03B 17/00; G03B 17/08

(52) U.S. Cl. 348/220.1; 396/421; 396/25; 348/E05.024

(57) ABSTRACT

In the preferred embodiment, the camera system for a weapon includes a camera subsystem, a mounting mechanism adapted to mount to the weapon, a bushing located between the camera subsystem and the mounting mechanism and adapted to reduce the propagation of undesirable motion and vibrations from the weapon to the camera subsystem, and an end cap connected to the bushing and selectively fastenable to the proximal end of the camera subsystem. The camera subsystem preferably has a distal end and a proximal end and including an image sensor located at the distal end and a memory device connected to the image sensor and accessed from the proximal end. The end cap preferably facilitates a waterproof seal of the memory device when fastened to the camera subsystem and allows access to the memory device when not fastened to the camera subsystem.

### CROSS-REFERENCE TO RELATED APPLICATIONS

This application is a continuation-in-part of prior application Ser. No. 12/110,167 filed on 25 Apr. 2008 and entitled “Camera System with Isolator and Seal for a Hunting Weapon”, which claims the benefit of U.S. Provisional Application No. 60/914,540, filed on 27 Apr. 2007 and entitled “Camera System with Isolator and Seal for a Hunting Weapon”. Both applications are incorporated in their entirety by this reference.

### TECHNICAL FIELD

This invention relates generally to the camera field, and more specifically to an improved camera system for a weapon.

### BACKGROUND

Weapons are subject to known and undesirable forces and motion from several sources. First, pulling the string (as on a bow) or the trigger (as on a rifle) may cause motion in the leading or trailing hand. Also, vibration may occur as a result of the discharge of the projectile (arrow or bullet). If a camera is attached to the weapon with the purpose of photographically capturing the shot, then the motion or vibration might cause distortion or loss of an image of the target and could even cause damage to the camera. There is a need to dampen this vibration to increase the chances for successfully capturing the shot and protecting the camera.

While the weapon may be used indoors for practice, it is typically used outside for long periods of time in varying weather conditions. There is a need for additional weather protection for any photographic equipment attached to the weapon.

### BRIEF DESCRIPTION OF THE FIGURES

FIGS. 1 and 2 are isometric assembled and cross-section views, respectively, of the camera system of the preferred embodiment.

FIG. 3 is a side view of the camera system mounted to the riser portion of a hunting bow.

FIG. 4 is an isometric cross-section view of the camera system of the preferred embodiment, with the end cap unfastened from the camera subsystem.

FIG. 5 is an isometric view of the camera system of the preferred embodiment mounted to a rifle with a bracket of a first variation.

FIG. 6 is an isometric view of a bracket of a second variation.

### DESCRIPTION OF THE PREFERRED EMBODIMENT

The following description of the preferred embodiment of the invention is not intended to limit the invention to this preferred embodiment, but rather to enable any person skilled in the art to make and use this invention.

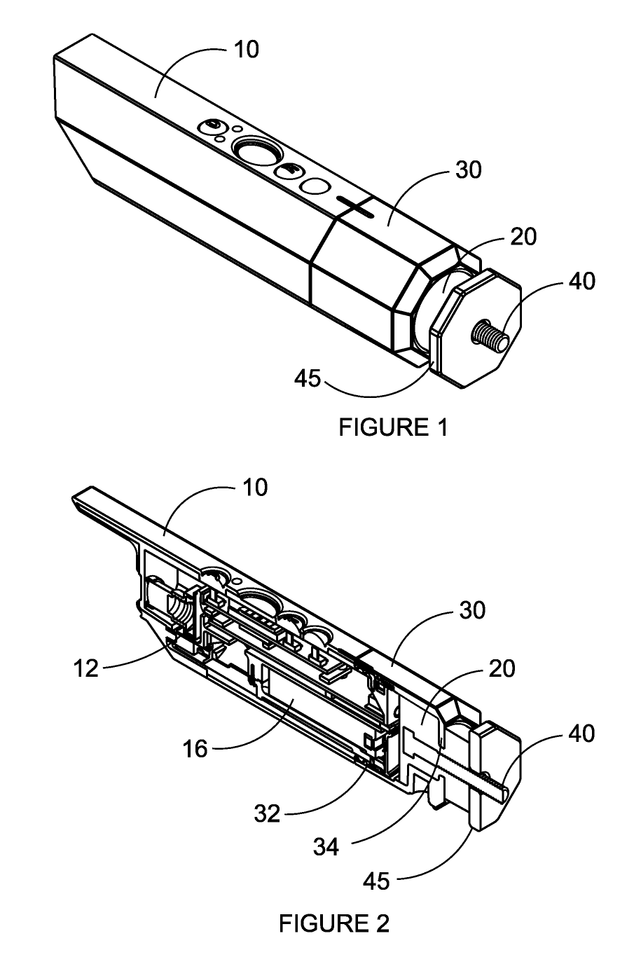

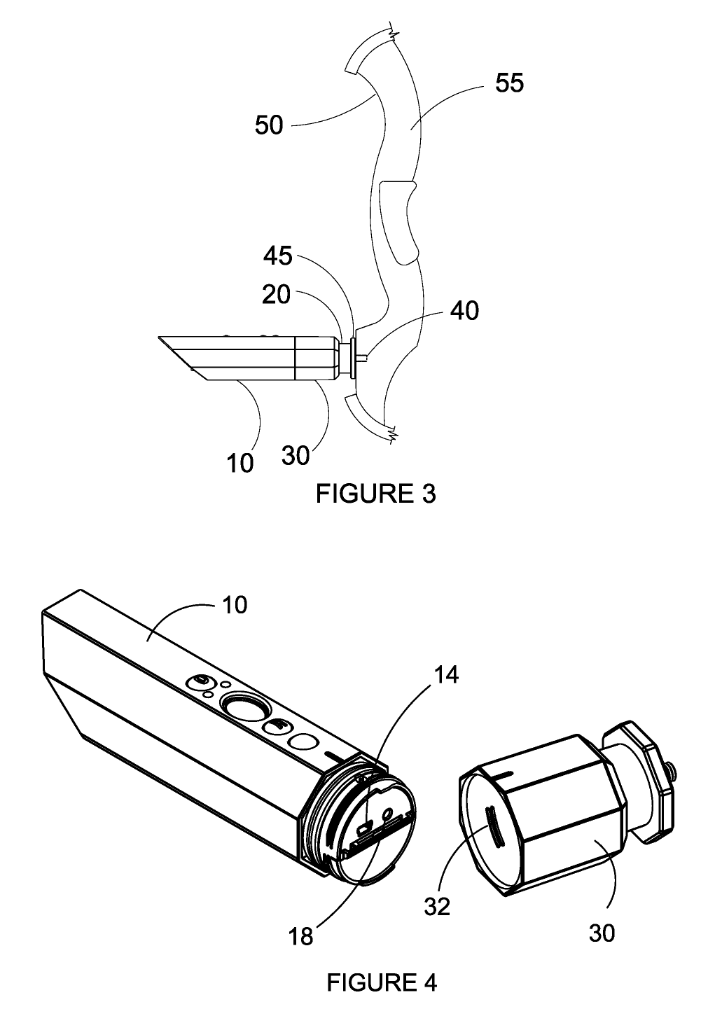

As shown in FIGS. 1 and 2, the preferred embodiment of the camera system includes a camera subsystem 10 with a memory device, a mounting mechanism 40, a bushing 20 located between the camera subsystem 10 and the mounting mechanism 40, and an end cap 30 connected to the bushing 20 and selectively fastenable to the camera subsystem 10. The end cap 30 facilitates a waterproof seal of the memory device when fastened to the camera subsystem 10, and allows access to the memory device when not fastened to the camera subsystem 10. The camera system has been specifically designed for a weapon such as a bow, rifle, paintball gun (as shown in FIGS. 3, 5, and 6), or any other weapon wherein the use of the weapon includes aiming the weapon at a target and releasing a projectile from the weapon towards the target. The camera system may, however, be used on other weapons or in any other suitable environment or application.

As shown in FIGS. 1 and 2, the camera subsystem 10 of the preferred embodiment functions to record images of the target of the weapon. The camera subsystem 10 preferably records video images, but may alternatively record still images. The camera subsystem 10 preferably includes an image sensor 12, such as a CCD image sensor or a CMOS image sensor, but may alternatively include any suitable image sensor. The camera subsystem 10 preferably includes a memory device, and more preferably includes a solid-state memory device to minimize both energy consumption and size. The camera subsystem 10 is preferably generally cylindrical with the image sensor located at a distal end of the cylindrical shape and the memory device connected to the image sensor and accessed from a proximal end of the cylindrical shape. The word “cylindrical” is used loosely to mean any tube-like shape with a generally elongated length and a generally circular cross-section, and is meant to include a hexagonal shaped tube.

In one variation, as shown in FIG. 4, the camera subsystem 10 includes a communication port 14 located on the distal end of the camera subsystem 10. The communication port 14 functions to allow communication with the memory device. In this variation, the end cap 30 facilitates a waterproof seal of the communication port 14 when fastened of the camera subsystem 10, and allows access to the communication port 14 when not fastened to the camera subsystem 10. The communication port 14 also functions to allow communication by a computer device (and, thus, may adhere to the USB, IEEE 1394, or Category 5 standards), by a display device (and, thus, may adhere to the Composite video, Component video, S-Video, DVI, HDMI, VGA, or Mini-VGA standards), or any other suitable device.

In another variation (not shown in the FIGURES), the memory device is removable from the camera subsystem through the distal end of the camera subsystem. In this variation, the end cap prevents removal of the memory device when fastened on the camera subsystem and allows removal of the memory device when not fastened to the camera subsystem. The memory device may be removable such as a memory cards (sold under the tradenames CompactFlash, Memory Stick, Secure Digital, and xD), a USB flash drive, or any other suitable removable memory device.

As shown in FIGS. 1 and 3, the mounting mechanism 40 of the preferred embodiment functions to mount the camera system to the weapon 50. The mounting mechanism 40 is preferably a stud that matches in thread and diameter the standard tapped hole in the riser portion 55 of the hunting bow 50 that exists in the majority of modern hunting bows. The tapped hole typically allows for the mounting of counter-balance and vibration dampening devices. When attached to the standard tapped hole in the riser portion 55 of the hunting bow 50, the camera system acts as a counter-balance and vibration dampening device. The mounting mechanism 40 may also attach to various adapters conceived for use with other forms of weaponry. In one variation, the camera system may also include a locking washer 45. The locking washer 45 functions to tighten the camera system to the weapon 50 via the mounting mechanism 40. The locking washer 45 is preferably a disc shape with a tapped hole that matches in thread and diameter of the mounting mechanism 40. The locking washer 45 tightens against the riser 55 of the bow 50 or other various adapters conceived for use with other forms of weaponry, allowing the camera to be properly aligned on its proper axis.

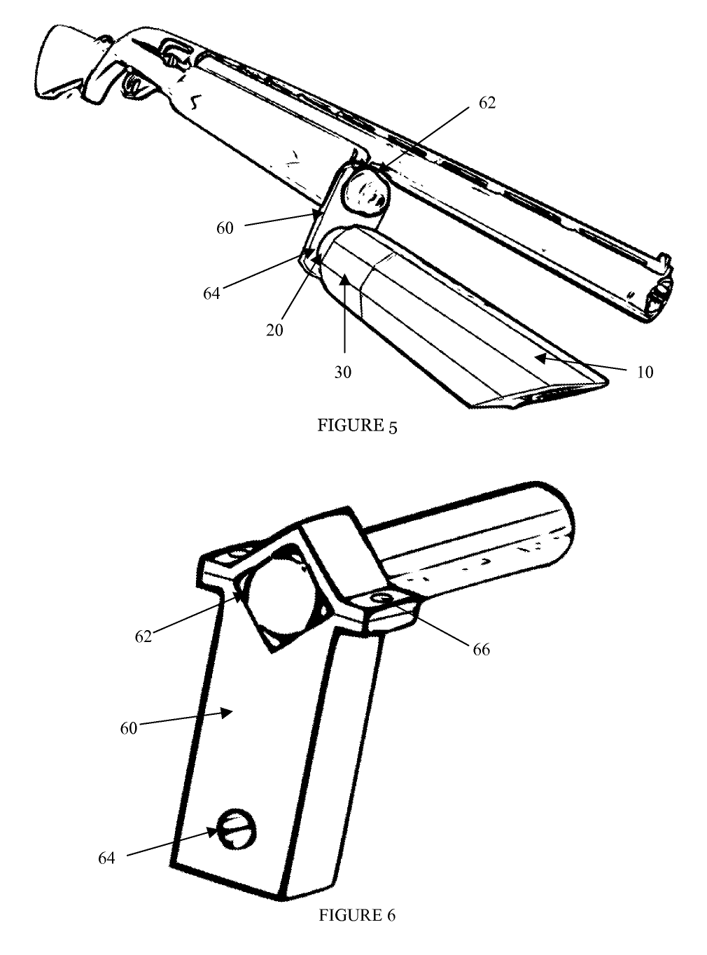

As shown in FIGS. 5 and 6, the mounting mechanism 40 may also include a bracket 60. The bracket 60 functions to mount the camera system to a weapon 70 where a tapped hole is not available, for example, on a rifle or paintball gun. The bracket 60 preferably includes a weapon mount hole 62 and a camera mount hole 64, but may alternatively include other mounting features. As shown in FIG. 5, a first variation of the bracket 60 is preferably applied to a rifle or gun that includes a magazine with a protrusion that accepts a magazine cap. The weapon mount hole 62 preferably mounts onto the protrusion on the magazine of the weapon and is secured to the weapon by the magazine cap. This variation may alternatively be mounted on any other component of any other weapon that contains a protrusion onto which the weapon mount hole 62 may be mounted to. In weapons where a cap is not available, the mounting mechanism 40 may include a fastener that functions to secure the bracket 60 onto the protrusion on the weapon. In weapons where the protrusion extends in a direction non-parallel to the direction of weapon aim, the bracket 60 may include angle geometry to arrange the line of sight of the camera system to be parallel to the weapon aim. As shown in FIG. 6, a second variation of the bracket 60 is preferably applied to any weapon with a barrel. The weapon mount hole 62 is preferably a clamp that is tightened around the barrel of the weapon using fasteners 66 such as screws, locking washers, rivets, or any other suitable fastening mechanism. In both variations, the camera mount hole 64 functions to allow the camera system to be mounted to the bracket 60. The camera mount hole 64 preferably includes threads that match the threads of the stud mentioned above to allow the camera system assembly described above to mount to the camera mount hole 64. Alternatively, the camera mount hole 64 may be mounted around the bushing 20 through the end cap 30. However, any other configuration for the camera mount hole 64 and the camera system wherein the bushing 20 separates the camera subsystem 10 and the bracket 60 may be used.

As shown in FIG. 2, the bushing 20 of the preferred embodiment functions as a separation between the camera subsystem 10 and the mounting mechanism 40 effecting a reduction in the undesirable motion and vibrations transferred to the camera subsystem 10 from the weapon and possibly protecting the camera subsystem 10 from shock damage. The bushing 20 may further function to orientate the camera subsystem 10 toward the target of the weapon. The bushing 20 is preferably made of a rubberized or polymerized material, similar to the bushing described in U.S. Pat. No. 6,802,307, filed 6 Jun. 2002, and entitled “Vibration Absorber For An Archery Bow”, which is hereby incorporated in its entirety. The bushing 20 may, however, include a spring, a fluid material, or any other suitable method or device that orientates the camera subsystem 10 toward the target of the weapon, while dampening and isolating vibration between the weapon and the camera subsystem 10. The bushing 20 preferably has a cylindrical shape with a distal end and a proximal end. The proximal end of the bushing 20 defines an exit for the mounting mechanism 40, which is partially located within the bushing 20.

As shown in FIGS. 1, 2, and 4, the end cap 30 of the preferred embodiment is connected to the bushing 20 and selectively fastenable to the proximal end of the camera subsystem 10. The end cap 30 functions to facilitates a waterproof seal of the memory device when fastened to the camera subsystem 10 (shown in FIG. 1) and allows access to the memory device when not fastened to the camera subsystem 10 (shown in FIG. 4). The end cap 30 also functions to provide a relatively rigid attachment of the camera subsystem 10 to the bushing 20. The end cap has a generally tubular shape with distal opening and a proximal opening. The distal opening preferably includes threads 32 (shown in FIGS. 2 and 4) with corresponding external O-rings to mate and seal with a portion of the camera subsystem 10, but may alternatively include pressure fittings or any suitable device or method to seal with the camera subsystem 10. The proximal opening of the end cap 30 preferably includes an inward flange 34 (shown in FIG. 2) and mates and seals with a “narrowed waist” section of the bushing 20, but may alternatively include any suitable device or method to seal with the bushing 20.

As shown in FIGS. 2 and 4, in the preferred embodiment, the camera subsystem 10 also includes a power source 16 (shown in FIG. 2), which functions to power camera subsystem 10. In one variation, the camera subsystem 10 includes a power port 18 (shown in FIG. 4) located on the distal end of the camera subsystem 10. The power port 18 functions to allow recharging of the power source 16. In this variation, the end cap 30 facilitates a waterproof seal of the power port 18 when fastened of the camera subsystem 10 and allows access to the power port 18 when not fastened to the camera subsystem 10. In another variation, the power source 16 is removable from the camera subsystem 10 through the distal end of the camera subsystem 10. In this variation, the end cap 30 prevents removal of the power source 16 when fastened of the camera subsystem 10 and allows removal of the power source 16 when not fastened to the camera subsystem 10.

As a person skilled in the art will recognize from the previous detailed description and from the figures and claims, modifications and changes can be made to the preferred embodiments of the invention without departing from the scope of this invention defined in the following claims.

I claim:

1. A camera system for a weapon, comprising:
a camera subsystem having a distal end and a proximal end and including an image sensor located at the distal end and a memory device connected to the image sensor and accessed from the proximal end;
a mounting mechanism, including a bracket, adapted to mount to the weapon;
a bushing located between the camera subsystem and the mounting mechanism and adapted to reduce the propagation of undesirable motion and vibrations from the weapon to the camera subsystem; and
an end cap connected to the bushing and selectively fastenable to the proximal end of the camera subsystem, wherein the end cap facilitates a waterproof seal of the memory device when fastened to the camera subsystem and allows access to the memory device when not fastened to the camera subsystem.

2. The camera system of claim 1, wherein the camera subsystem has a tubular shape including an image sensor located at the distal end of the cylindrical shape and a memory device connected to the image sensor and accessed from the proximal end of the tubular shape.

3. The camera system of claim 1, wherein the image sensor is selected from the group consisting of a CCD images sensor and a CMOS image sensor.

4. The camera system of claim 1, wherein the camera subsystem includes a communication port located on the distal end of the camera subsystem and adapted to allow communication with the memory device, wherein the end cap facilitates a waterproof seal of the communication port when fastened of the camera subsystem and allows access to the communication port when not fastened to the camera subsystem.

5. The camera system of claim 4, wherein the communication port is selected from the group consisting of USB, IEEE 1394, and Category 5.

6. The camera system of claim 4, wherein the communication port is selected from the group consisting of Composite video, Component video, S-Video, DVI, HDMI, VGA, and Mini-VGA.

7. The camera system of claim 1, wherein the memory device is removable from the camera subsystem through the distal end of the camera subsystem, wherein the end cap prevents removal of the memory device when fastened of the camera subsystem and allows removal of the memory device when not fastened to the camera subsystem.

8. The camera system of claim 1, wherein the camera subsystem includes a power source adapted to power the image sensor.

9. The camera system of claim 8, wherein the camera subsystem includes a power port located on the distal end of the camera subsystem and adapted to allow recharging of the power source, wherein the end cap facilitates a waterproof seal of the power port when fastened of the camera subsystem and allows access to the power port when not fastened to the camera subsystem.

10. The camera system of claim 8, wherein the power source is removable from the camera subsystem through the distal end of the camera subsystem, wherein the end cap prevents removal of the power source when fastened of the camera subsystem and allows removal of the power source when not fastened to the camera subsystem.

11. The camera system of claim 1, wherein the bracket includes a weapon mount hole that mounts to a protrusion on the weapon and a camera mount hole that mounts to the camera subsystem, and wherein the bushing is positioned in between the bracket and the camera subsystem.

12. The camera system of claim 11, wherein the mounting mechanism further includes a fastener that secures the bracket to the weapon, the fastener selected from the group consisting of: cap, screw, locking washer, clamp, and rivet.

13. The camera system of claim 11 wherein the weapon mount hole mounts to the barrel of a weapon selected from the group consisting of: a rifle, a gun, a paintball gun, and a firearm.

14. The camera system of claim 1, wherein the bushing is made of a rubberized or polymerized material.

15. The camera system of claim 1, wherein the bushing has a distal end and a proximal end, wherein a portion of the mounting mechanism is located within the bushing, and wherein the proximal end of the bushing defines an exit for the mounting mechanism.

16. The camera system of claim 15, wherein the end cap has a generally tubular shape with distal opening and a proximal opening, wherein the distal end of the bushing is located within the end cap, and wherein the proximal end of the end cap defines an exit for the bushing.

17. The camera system of claim 16, wherein the proximal end of the end cap seals against the bushing.

18. The camera system of claim 1, wherein the end cap has a generally tubular shape with distal opening and a proximal opening, wherein the distal end of the end cap is selectively fastenable to the proximal end of the camera subsystem, and wherein the proximal end of the end cap seals against the bushing.

19. The camera system of claim 18, wherein the distal end of the end cap and the proximal end of the camera subsystem include mating threads.

20. A camera system for a weapon with a protrusion, comprising:
a camera subsystem having a tubular shape with a distal end and a proximal end and including an image sensor located at the distal end, a memory device connected to the image sensor, and a communication port located on the distal end of the camera subsystem and adapted to allow communication with the memory device;
a mounting mechanism including a bracket that mounts to the protrusion on the weapon;
a bushing located between the camera subsystem and the mounting mechanism and adapted to reduce the propagation of undesirable motion and vibrations from the weapon to the camera subsystem; and
an end cap having a generally tubular shape with proximal opening and a distal opening, wherein the proximal opening of the end cap seals against the bushing, wherein the distal opening of the end cap is selectively fastenable to the proximal end of the camera subsystem, wherein the end cap facilitates a waterproof seal of the communication port when fastened to the camera subsystem and allows access to the communication port when not fastened to the camera subsystem.
